(19) United States
(12) Patent Application Publication
(10) Pub. No.: US 2003/0172048 A1
(43) Pub. Date: Sep. 11, 2003

(54) Text search system for complex queries

(75) Inventor: Steven Victor Kauffman, San Jose, CA (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: Business Machines Corporation

(21) Appl. No.: 10/091,885

(22) Filed: Mar. 6, 2002

(51) Int. Cl. G06F 7/00

(52) U.S. Cl. 707/1

(57) ABSTRACT

A device for retrieving stored data includes means for assigning at least one prioritized attribute to the data prior to storage and means for retrieving the stored data, where the stored data is retrieved in an order determined by the priority of the at least one prioritized attribute assigned to the stored data. The stored data may include an identifier, and the at least one prioritized attribute may be encoded into the identifier. The stored data, means for assigning, and means for retrieving may be connected to and distributed over a network having a plurality of nodes.

### BACKGROUND OF THE INVENTION

1. Field of the Invention

The present invention relates to search engines for digitally stored documents, and in particular to an improved method for storing and retrieving digital documents.

2. Discussion of the Background Art

Information retrieval can be thought of as the process of selecting and presenting specific documents from within a collection of documents. The documents may be selected according to a user's description of topics, or more specifically, words describing the content of documents a user desires to review. For the purposes of this invention, a document may be any compilation of information in any suitable format or combinations of formats, including, for example, text, video, audio, or multimedia. Documents may also include traditional collections of human generated text or machine generated “psuedo-documents,” that is, a collection of attributes or a record, created to enable searching of a digital asset. The retrieval of documents using a computing device is an integral activity of many day to day business and personal activities. Document retrieval is especially useful and prevalent in Internet applications.

Two known methods of preparing documents for retrieval include keyword based preparation and context based preparation. Using the keyword based method, an operator, at the time of document archival, may attach a set of terms that, in the opinion of the operator, describe the content of the document being stored. The words or phrases may or may not occur within the document and represent a subjective judgment by the operator of what terms may be used as queries in the future. In contrast, the context based method could be an automated method where a text engine reviews each word in a document, and based on a set of criteria, words and phrases may be selected and given a weight or priority as a search term. In one example of a context based preparation method, each word in the document could be selected as a search term and given a weight based on the number of occurrences of the word.

Both methods typically include the search terms as part of one or more index files. The system may include other index files, for example, containing the search terms of the document and their locations within each document. The index files provide a significant advantage as far as locating search terms, but are disadvantageous in that they represent a significant amount of overhead in a typical retrieval system.

Regardless of the method utilized to prepare the document for retrieval, the user who wants to find an item does so by constructing a set of search criteria. The search criteria may be as simple as a single word, or may be a combination of words and phrases linked by logical or Boolean operators. The search terms are typically submitted to a system, typically a search engine, which generates a search process and retrieves documents based on the search criteria. Some search processes allow the search criteria to include words or phrases having a maximum distance between them in the document, for example, the word “final” within 5 words of “office action.” LEXIS™ and WESTLAW™ are renown for this type of feature. It may also be possible to specify other criteria including searching for a particular text string.

FIG. 1 shows a block diagram of a generalized search engine 10. User terminal 15, text engine 20, database 35, and sorting processor 65 are all connected through network 40.

User terminal 15 is typically capable of generating a query, receiving and displaying the results of that query, and retrieving and displaying documents included in the results. User terminal 15 may be operated by a person or may generate queries in response to a program or an automated process. For purposes of the invention, a user may include a person, program, automated process, or any other device or technique for generating queries for a search engine. Text engine 20 includes capabilities for directing the addition of documents 50 to database 35, and initiating index processes 60, search processes 25, and intersection processes 30. Text engine 20 also includes capabilities for initiating a process 45 for assigning unique identifiers 70 to documents, and for generally controlling the activities of search engine 10. Documents 50 and index files 55 are typically located in database 35.

Documents 50 may be loaded into database 35 either manually or automatically under the direction of text engine 20. As part of the loading process, text engine 20 may first assign a random number to each document as a file name or document key, also known as a unique identifier 70, through unique identifier process 45. Text engine 20 may also initiate indexing processes 60 that generate and update various index files 55. Indexing files 55 may include a table of unique words identified in each document 50. In addition, for each word in the unique words table, indexing processes 60 may add pointers to the table pointing to the documents containing that word. Indexing processes 60 may also create other index files 55 including ones containing the number of occurrences of each word in each document and their location within each document.

Once database 35 is operational, a user may generate a query using user terminal 15. The query usually includes a number of key words which may be connected by logical operators (e.g., AND, OR, NOT, etc.) The query is submitted to text engine 20 which initiates at least one search process 25. For complex queries, text engine 20 may initiate a number of search processes 25, one for each component or segment of the query. If a single search process 25 is utilized, the search process 25 will return a list of documents that satisfy the search criteria. A sorting process 65 will typically sort the list in unique identifier order. The items in the list may be given a rank as to relevance and then displayed on user terminal 15. In the case where multiple search processes 25 are employed, when the search processes 25 are complete, text engine 20 coordinates at least one intersection process 30 that generates a list of documents that are common to each of the search results. The list is then sorted in unique identifier order by sorting process 65. The document list may then be ordered according to relevancy and then presented to the user through user terminal 15. Multiple search processes 25 and intersection processes 30 typically take significant processing time to complete and also consume relatively large areas of storage space. This may introduce delays and storage management problems if the intermediate results from the individual search processes 25 are large.

A typical search request causes the retrieval of a large number of documents which satisfy the search criteria. However, because of the method used to prepare the documents for entry into the database, the documents are usually not organized in a manner helpful to the user. In addition, many of the actual entries retrieved are not useful. This is usually because the user usually does not know how the documents may have been organized or because the user has no knowledge of the search terms and/or weights that may have been generated when preparing the documents for entry. As such, anything relevant but described in a slightly different manner may not be found. At the same time, a large number of irrelevant documents may also be found, resulting an inefficient manual sorting by the user.

Generating multiple search processes, an intersection process, and receiving a search report with many irrelevant entries may be particularly disadvantageous when a user generates multiple search requests for documents, each time searching for documents having one or more of a particular set of attributes. In an application where a user generates queries on a periodic basis for documents having a certain set of attributes it would be beneficial to perform those searches without generating additional search and intersection processes. It would also be helpful to perform searches that yield results that are pertinent and that do not include a large number of irrelevant documents.

### SUMMARY OF THE INVENTION

This invention is directed to a device for retrieving stored data that includes a processor for assigning at least one prioritized attribute to the data prior to storage and a processor for retrieving the stored data, where the stored data is retrieved in an order determined by the priority of the at least one prioritized attribute assigned to the stored data. The stored data may include an identifier, and the at least one prioritized attribute may be encoded into the identifier. The stored data, processor for assigning, and processor for retrieving may be connected to and distributed over a network having a plurality of nodes.

The invention is also directed to a method for retrieving stored data, including assigning at least one prioritized attribute to the data prior to storage, and retrieving the stored data in an order determined by the priority of at least one prioritized attribute assigned to the stored data.

The invention also includes a program storage device readable by a machine, tangibly embodying a program of instructions executable by the machine to perform a method for retrieving stored data, where the method includes assigning at least one prioritized attribute to the data prior to storage, and retrieving the stored data in an order determined by the priority of at least one prioritized attribute assigned to the stored data.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a block diagram of a typical search engine;

FIG. 2 is a block diagram of a device according to the invention;

FIG. 3 shows a flow chart of a procedure for producing an encoded document key;

FIG. 4 shows a flow chart of the operations of the computing device using the encoded document key; and

FIG. 5 shows a block diagram of the computing device utilizing a date attribute as part of the encoded document key.

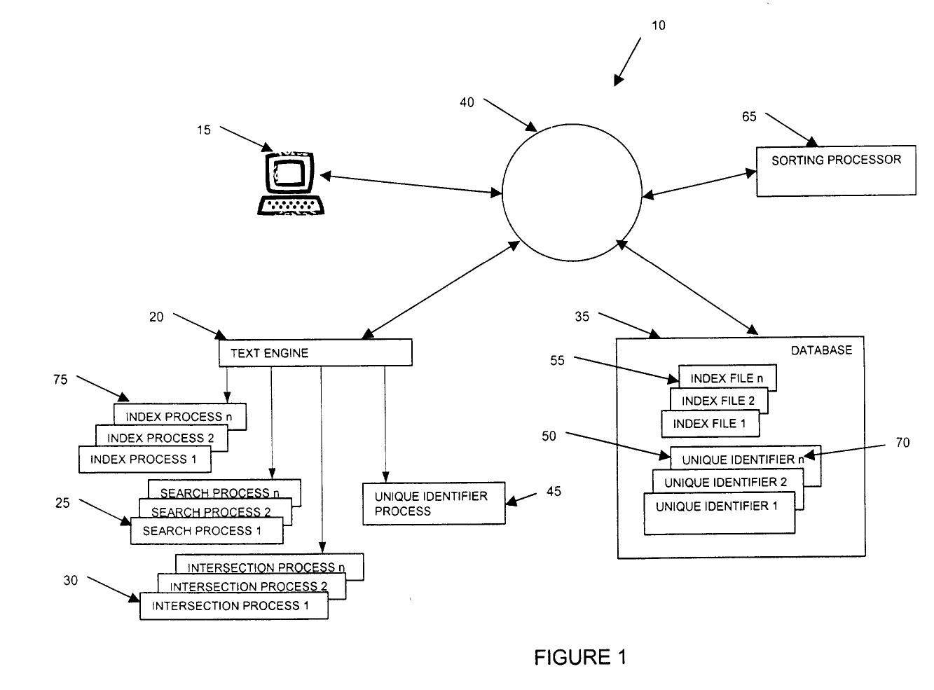

### DETAILED DESCRIPTION OF THE INVENTION

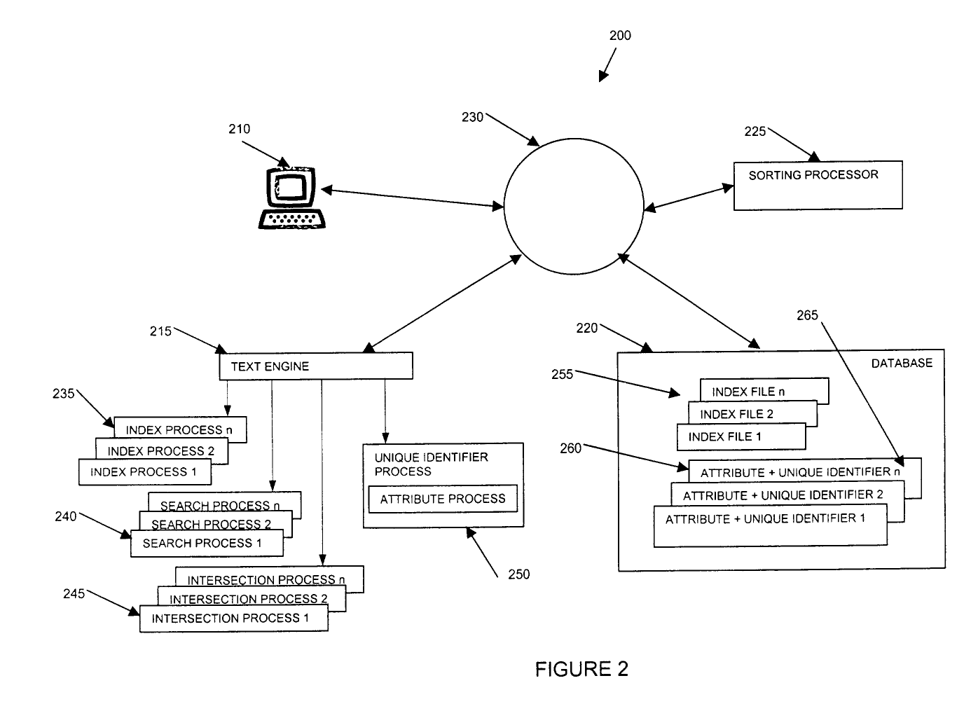

FIG. 2 shows an example of a computing device 200 embodied as a unique search engine in accordance with the teachings of the invention. User terminal 210, text engine 215, database 220, and sorting processor 225 are all coupled to network 230.

Text engine 215 is capable of initiating index processes 235, search processes 240, intersection processes 245, and in general, controlling the operation of computing device 200. Text engine 215 is also capable of initiating a unique identifier process 250 which will be described below.

Database 220 typically includes index files 255 and documents 260. Sorting processor 225 operates on the results of a search process 240 when a single search process has been initiated, and sorts the results in document key order. When multiple search processes 240 are initiated and intersection process 245 is used to intersect the results of the search processes 240, sorting processor 225 sorts the results of the intersection process 245 by document keys. In either case, the sorted list of documents may be displayed to the user through user terminal 210. If the user is a program or process, the sorted list of documents may simply be passed to the program or process.

Text engine 215 directs the loading of documents 260 into database 220. According to the invention, as part of the loading process, text engine 220 assigns a special document key 265 to each document utilizing unique identifier process 250. Special document key 265 can begin as a random number, or any other document identifier that may be initially generated by text engine 215. In addition, unique identifier process 250 encodes one or more document attributes into the special document key 265, thus producing a unique identifier that includes certain attributes of the document 260. Examples of attributes that may be encoded in special document key 265 may include the date the document was created, the size of the document, the number of occurrences of a specific word or words, or any other attributes of the document 260 that are suitable for encoding. The document 260 with its special document key 265 is then stored in database 220. As part of the loading process text engine 215 may also initiate various indexing processes 235 that create any number and type of index files 255 in database 220.

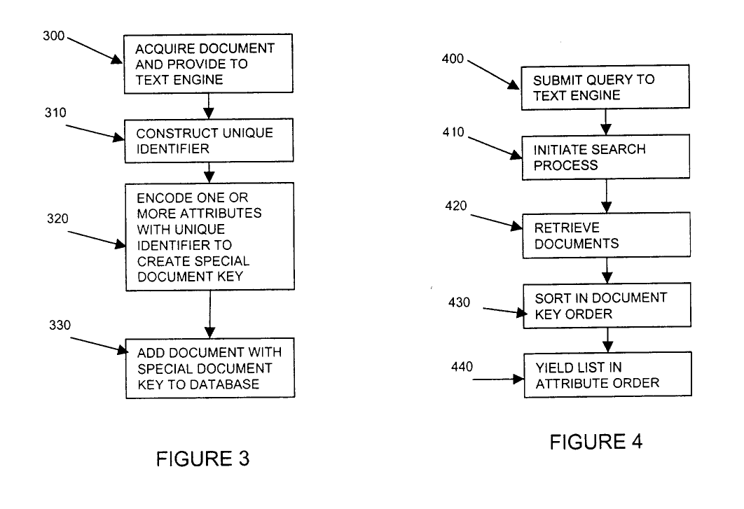

FIG. 3 shows a flowchart of the unique identifier process 250. In step 300 document 260 is acquired and is provided to text engine 215. Text engine 215 then constructs a unique identifier for document 260 in step 310. Selected attributes of document 260 are then encoded with the unique identifier to create special document key 265 in step 320. The attributes may be predetermined, for example, the same set of attributes may be encoded for each one of a group of documents, or the attributes may be individually selected for each document. In step 330, document 260 and special document key are added to database 220.

FIG. 4 shows the operation of computing device 200 utilizing special document key 265. A user generates a query which is submitted to text engine 215 in step 400. In step 410 text engine 215 initiates a search process 240 based on the query. In step 420, the search process retrieves a list of documents 260 that satisfy the search criteria. Sorting processor 225 then sorts the list in document key order in step 430.

In a preferred embodiment, unique identifier process 250 encodes attributes in special document key 265 such that sorting processor 225, in sorting the list of documents in document key order, actually sorts the document list in attribute order. In other words, special document key 265 is constructed so that the attributes are represented in a specific manner in special document key 265, such that when sorting processor 225 sorts the retrieved list by document keys, it also sorts the retrieved list in attribute order. Thus, as shown in step 440 of FIG. 4, sorting processor 225 yields a list in attribute order.

This is advantageous in that, if a user knows how the attributes are encoded in the special document key 265, or at least how the attributes will be ordered by sorting processor 225, the user may construct queries that require a minimum number of multiple search processes 240 and avoid intersection processes 245. Utilizing these queries, text engine 215 may return a document list already sorted in order of the attributes desired by the user. In addition, the document list is produced in a reduced time period and with less of an impact on system resources than conventional searching techniques. Also, by understanding how the attributes will be ordered, a user has the ability to construct queries that yield results that are organized in a manner that is more useful to the user and that include an increased number of relevant documents.

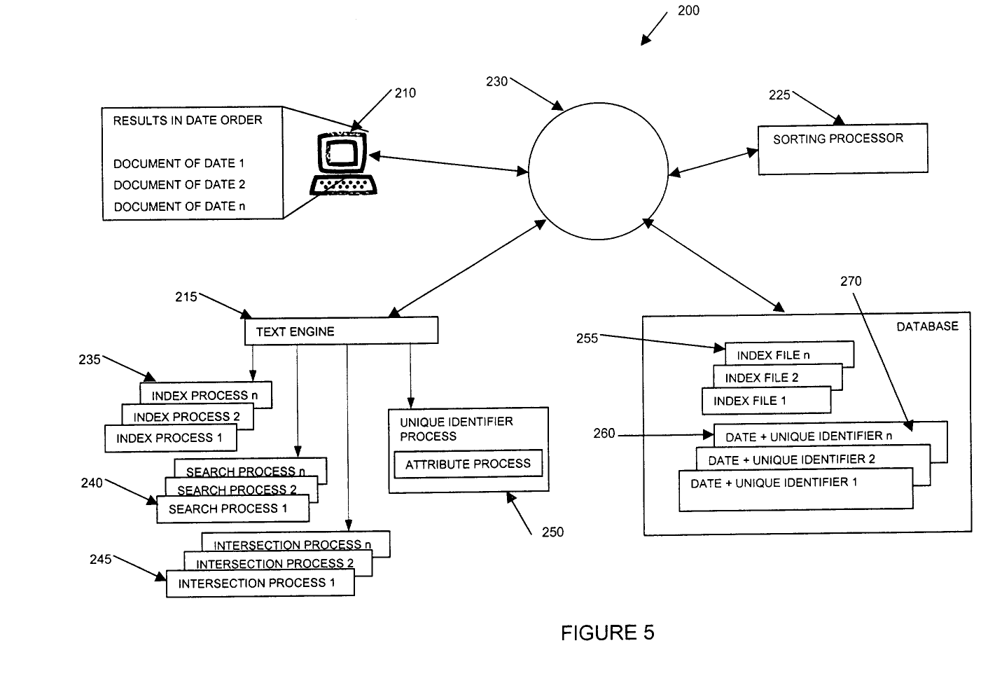

FIG. 5 shows an example of computing device 200 utilizing a special document key 270 that includes a rudimentary document attribute, for example, the date a document was published.

A user determines that a set of documents to be stored in database 220 will be queried periodically, and that a common query component will be the date the documents were published. As text engine 215 directs the loading of documents 260 into database 220, unique identifier process 250 encodes the date the document was published into the special document key 270. The document 260 with its special document key 270 is then stored in database 220, along with any index files 255 that may have been produced by indexing processes 235.

Unique identifier process 250 encodes the published date attribute in special document key 270 such that sorting processor 225 will sort a list of documents returned from search process 240 or intersection process 245 in published date order.

The user generates a query for documents having a specific word combination which is submitted to text engine 215. A search process 240, initiated by text engine 215 returns a list of documents satisfying the query. When sorting process sorts the results of the search process, the sorted document list includes all documents having the specific word combination in published date order. Thus, multiple search processes have been minimized and the intersection process has been avoided by coding a particular attribute into the special document key 270.

It should be understood that while the examples described herein describe a specific attribute singly encoded into the special document key, any attribute or any number of attributes may be encoded into the special document key to facilitate providing a user with searching processes that are more efficient in their use of system resources and that return documents that are relevant to the user.

It should also be understood that database 220 may exist as a single integrated entity or may exist as a distributed database including any number of processing systems, document stores, and indexes located anywhere on network 230. In the examples shown in FIGS. 2 and 5, database 220 is shown as a single entity for purposes of explanation.

It should further be understood that network 230 may include any number or combination of wide area networks, local area networks, intranets, virtual private networks, and the Internet, or any other network that may be suitable for purposes of the invention described herein.

While the computing device 200 and its components are described in the context of a various engines, processes, and processors, it should be understood that that the computing device 200 may be implemented solely in software or solely in hardware, or may be implemented in any combination of hardware and software suitable for providing the functions of the present invention. It should also be understood that the invention includes a program storage device readable by a machine, tangibly embodying a program of instructions, executable by the machine, to perform a method according to the teachings of the present invention. The program storage device may include, for example, a magnetic tape, a floppy disk, a CD ROM, or any other storage device suitable for storing such a program.

It can thus be appreciated that while the invention has been particularly shown and described with respect to preferred embodiments thereof, it will be understood by those skilled in the art that changes in form and details may be made therein without departing from the scope and spirit of the invention.

We claim:

1. A device for retrieving stored data comprising:
a processor for assigning at least one prioritized attribute to the data prior to storage; and
a processor for retrieving said stored data, wherein said stored data is retrieved in an order determined by the priority of said at least one prioritized attribute assigned to said stored data.

2. The device of claim 1, wherein said stored data comprises an identifier, and said at least one prioritized attribute is encoded into said identifier.

3. The device of claim 1, wherein said stored data comprises a plurality of digital documents.

4. The device of claim 1, wherein said stored data is stored in a database.

5. The device of claim 1, wherein said stored data, said processor for assigning, and said processor for retrieving are connected by a network having a plurality of nodes.

6. The device of claim 5, wherein said stored data is distributed over said plurality of nodes of said network.

7. The device of claim 5, wherein said processor for assigning is distributed over said plurality of nodes of said network.

8. The device of claim 5, wherein said processor for retrieving is distributed over said plurality of nodes of said network.

9. A method for retrieving stored data comprising:
assigning at least one prioritized attribute to the data prior to storage; and
retrieving said stored data in an order determined by the priority of said at least one prioritized attribute assigned to said stored data.

10. The method of claim 9, wherein said stored data comprises an identifier, and said at least one prioritized attribute is encoded into said identifier.

11. The method of claim 9, wherein said stored data comprises a plurality of digital documents.

12. The method of claim 9, further comprising storing said stored data in a database.

13. The method of claim 9, wherein said stored data is distributed over a plurality of network nodes.

14. The method of claim 13, wherein assigning at least one prioritized attribute is performed over a plurality of network nodes.

15. The method of claim 13, wherein retrieving said stored data is performed over a plurality of network nodes.

16. A program storage device readable by a machine, tangibly embodying a program of instructions executable by the machine to perform a method for retrieving stored data, said method comprising:
assigning at least one prioritized attribute to the data prior to storage; and
retrieving said stored data in an order determined by the priority of said at least one prioritized attribute assigned to said stored data.

17. The program storage device of claim 16, wherein said stored data comprises an identifier, and said at least one prioritized attribute is encoded into said identifier.

18. The program storage device of claim 16, wherein said stored data is distributed over a plurality of network nodes.

19. The program storage device of claim 18, wherein assigning at least one prioritized attribute is performed over a plurality of network nodes.

20. The program storage device of claim 18, wherein retrieving said stored data is performed over a plurality of network nodes.
